(19) United States
(12) Patent Application Publication
(10) Pub. No.: US 2005/0027487 A1
(43) Pub. Date: Feb. 3, 2005

(54) Product defect analysis and resolution system

(76) Inventor: Supriya Iyer, Los Altos, CA (US)

Correspondence Address: KENYON & KENYON, 1500 K STREET, N.W., SUITE 700, WASHINGTON, DC, 20005, US

(21) Appl. No.: 10/847,324

(22) Filed: May 18, 2004

Related U.S. Application Data
(60) Provisional application No. 60/486,893, filed on Jul. 15, 2003.

(51) Int. Cl. G06F 11/30

(52) U.S. Cl. 702/185

(57) ABSTRACT

A defect analysis and resolution (DAR) system analyzes product performance data stored by a firm. The DAR system may store data representing product performance as a plurality of data objects, each object having fields representing various product performance parameters. The system also may store a database representing expected product performance data across the same parameters. If the system monitors a statistically significant deviation between actual performance data and expected performance data, it may trigger a defect analysis process. The defect analysis process may exchange product performance data with systems of possibly other market participants involving the same product. An analysis may be performed on a larger set of data to determine likely causes of product defects and possible resolution. Resolution solutions may be stored in a database for further consideration by members of the firm.

### BACKGROUND

Most modern firms employ computer systems to facilitate and manage their operations. Among other things, the computer systems build large databases that store information regarding the firms' operations and performance. For example, firms involved in the manufacture, distribution or sale of goods may maintain data describing the products' performance and their own efforts expended to facilitate the products' performance within a marketplace. Manufacturers may store data relating to product components, service performed on the products and complaints made by purchasers regarding the products. Product sellers or OEMs also store data regarding product sales and also regarding complaints or warranty claims made by product purchaser. Service firms may store data regarding service performed on a product, the nature of a product defect that necessitated the service and the like. Each of these market participants is likely to store only a portion of data that represents overall product performance.

There is a need in the art for an automated data diagnosis and resolution system that causes an exchange of product performance data among a plurality of market participants. There further is a need in the art for an automated analysis system that identifies likely product defects and causes therefore and a resolution system that can cause a firm to alter its processes to eliminate such defects.

### BRIEF DESCRIPTION OF THE DRAWINGS

FIG. 1 is a block diagram illustrating a computer network 100 according to an embodiment of the present invention.

FIG. 2 is a functional block diagram of a defect analysis and resolution unit according to an embodiment of the present invention.

FIG. 3 is a data flow diagram of a DAR unit and associated components according to an embodiment of the present invention.

FIG. 4 is a simplified block diagram of a computer platform suitable for use with the present invention.

### DETAILED DESCRIPTION

Embodiments of the present invention provide a defect analysis and resolution (DAR) system for product performance data stored by a firm. The DAR system may store data representing product performance as a plurality of data objects, each object having fields representing various product performance parameters. The system also may store a database representing expected product performance data across the same parameters. If the system monitors a statistically significant deviation between actual performance data and expected performance data, it may trigger a defect analysis process. The defect analysis process may exchange product performance data with agents (computer systems) of possibly other market participants involving the same product. An analysis may be performed on a larger set of data to determine likely causes of product defects and possible resolution. Resolution solutions may be stored in a database for further consideration by members of the firm. Moreover, such a system could generate proactive actions based on a type of defect identified which could support initiation of a recall, notify design engineering of problem so they can make appropriate adjustments to the next release of their product, notify parts planner so that they can change their plans for future deployments and still maintain customer service levels.

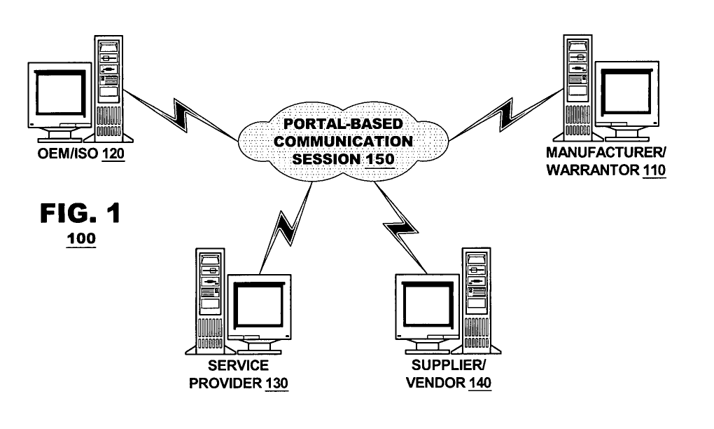

FIG. 1 is a block diagram illustrating a computer network 100 according to an embodiment of the present invention. The network 100 is illustrated as including computer systems operated by a manufacturer 110, an OEM or independent service organization (“ISO”) 120, a service provider 130 and a parts supplier 140. In FIG. 1, the manufacturer 110 is illustrated as including the defect analyzer, although such functionality may be provided in any of the other computer systems illustrated. The computer systems 110-140 interactive exchange product performance data according to protocols defined between them. The communication protocols and apparatus through which these systems 110-140 exchange data are not material for the present discussion and therefore have been illustrated as an abstract portal-based ‘communication session’ 150.

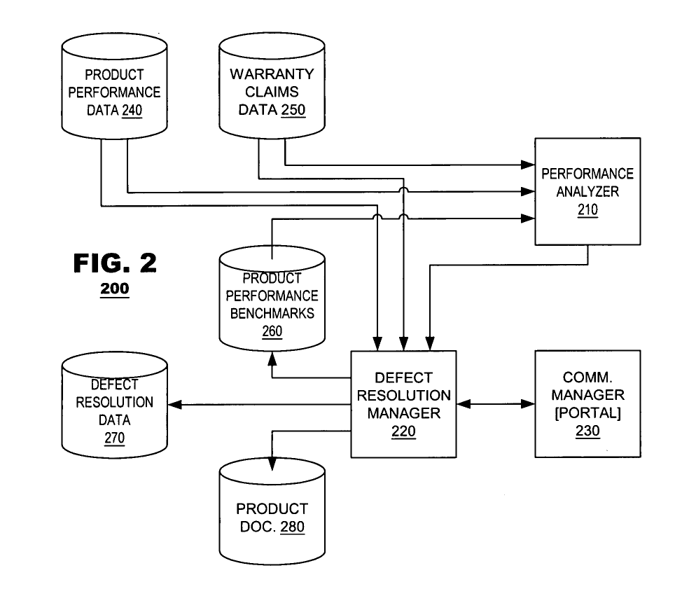

FIG. 2 is a functional block diagram of a defect analysis and resolution unit according to an embodiment of the present invention. As noted, the DAR may be a member of any of the systems 110-140 of FIG. 1. As illustrated, the DAR 200 may include a performance analyzer 210, a defect resolution manager 220 and a communication manager 230. The DAR 200 also may include several data elements, storing product performance data 240, warranty claims data 250, product performance benchmarks 260, defect resolution data 270 and technical manual data 280.

The product performance database 240 stores information regarding product failures or repairs. Product performance data may be gathered from sources such as repair service providers and parts centers (as appropriate for a given product). It may store data representing a product's serial number, dates and types of repairs performed on a given product, dates and types of maintenance performed and any causes noted for product failure. Product performance data may be stored in the product performance database 240 from other systems (not shown).

The warranty claims database 250 may store data representing warranty claims made with respect to each product. The warranty claims database may store information similar to the product performance database 240, noting products' serial numbers, types of repairs sought, types of maintenance performed and causes noted for product failure. The warranty claims database 250 also may indicate whether an owner's claim was covered by a warranty or not. Warranty claims data may be stored in the database 250 via other systems, such as a claims management system (not shown).

The product performance benchmarks database 260 may store data identify product performance expectations. For example, for various components within a product, the benchmarks database 260 may include data identifying an expected lifecycle or a mean time between failures (MTBF). The benchmarks database 260 may identify, on a percentage basis for example, components that are expected to be functional for identified periods of time (e.g., 95% operational two years from date of sale, 75% operational four years from date of sale, etc.).

The product analyzer 210 is an analytical tool that compares actual product performance to performance benchmarks to determine whether recorded data regarding distributed products (as recorded in databases 240, 250) is consistent with expectation benchmarks (represented in database 260). If the performance analyzer detects abnormal performance with respect to a product as a whole or a product component, it may engage the defect resolution manager 220.

The defect resolution manager 220 represents functionality sufficient to diagnose and remediate possible product defects. It may engage the communication manager 230 to exchange product performance data with computer systems of other participants in a product's distribution chain (e.g., systems 110-140 of distributors, service/repair organizations and product vendors).

The defect resolution manager 220 may perform analytical operations to classify abnormal product behavior according to various metrics. Essentially, using statistical techniques, the defect resolution manager may identify, for example, that a significant portion of product defects is localized in a particular product component. Alternatively, the defect resolution manager may identify that a significant portion of product failures occurs from products that are serviced by a particular repair organization. Hypothetically, the defect resolution manager may determine that a significant percentage of product failure occur through product misuse.

Product performance data models individual distributed products according to a number of different metrics, including for example, mean time between failure (MTBF), mean time to repair (MTTR), “wrench-time,” product defect codes (component failure, user error). The defect resolution manager 220 may run statistical analyses of such performance data to determine whether product failures can be clustered according to one or more object fields.

As noted, the defect resolution manager 220 may facilitate an exchange of data collaboratively with other systems for other participants in a product's distribution chain. The defect resolution manager 220, for example, may exchange product performance data with these other systems and receive product performance data regarding the same products or some other set of products where similar product failures are noted, to provide a universal set of performance data for analysis. Having supplemented the product performance data, clustering algorithms run by the defect resolution manager 220 may be applied.

When a product defect is isolated, the defect resolution manager 220 may generate resolution data to facilitate resolution of a product defect. For example, the defect resolution manager may amend data in the product performance benchmarks to revise product performance expectations if the expectations are determined to have been erroneous. Based on the type of defect noted, the defect resolution manager 220 may store data in a product documentation database 280 identifying kinds of product mis-use that have contributed to product failures. Such notes may be used to revise product documentation or technical manuals for products that are newly released. Further, depending on severity of product defects that are observed, the defect resolution manager may invoke a notification process (not shown) to generate alert notifications to product owners registered with the system.

The defect resolution manager 220 also may store data in a defect resolution database 270 that represents a cause of product failure and remedial steps. In so doing, the defect resolution manager 220 may generate a resolution history with respect to the product. Such resolution histories may be useful for a firm as it decides to renew relationships with product vendors, service firms and the like. For example, if a firm's defect resolution manager 220 received multiple notifications that a product component was the source of a product defect notwithstanding notifications sent to the component's manufacturers, a firm might consider finding an alternate supply of the unreliable components. Similarly, if a service organization were the source of product defect complaints because of faulty repair and continued to be a source of complaints following notice, again the firm might consider finding an alternative repair firm. The defect resolution database 270 therefore may store objects representing operations performed by the defect resolution manager, storing performance data that triggered the defect resolution manager, performance statistics that revealed the source of the product defects and any resolution performed (e.g., notification to others, revisions to product documentation, design defects).

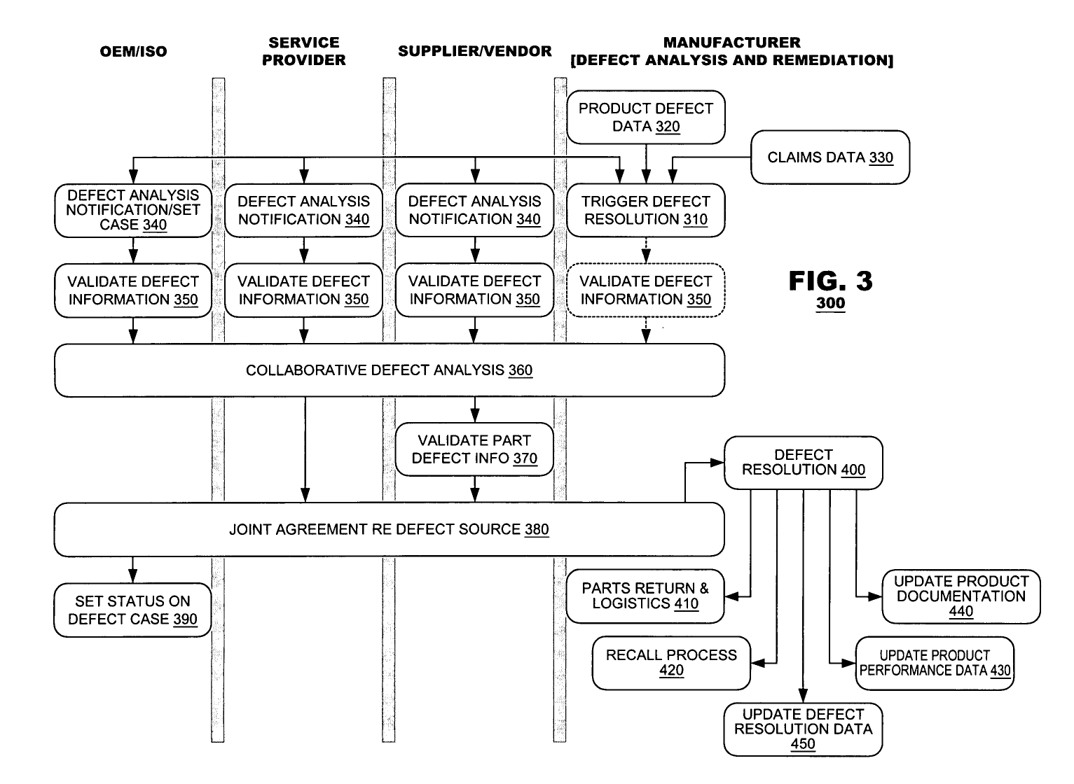

FIG. 3 provides an exemplary data flow of a DAR unit and associated components according to an embodiment of the present invention. Although the DAR unit is illustrated as being a component within a manufacturer's computer system, the DAR unit may be provided in any other system illustrated in FIG. 3 or even in systems of multiple participants.

According to an embodiment of the present invention, a defect resolution process 310 may be triggered by internal analyses of product defect data 320 or warranty claims data 320 but also by a defect notification 340 received from an external agent. In one embodiment, a defect notification 340 generated by any agent (say, the ISO) may be transmitted to every agent (the manufacturer, service providers and suppliers) in the distribution chain either directly or through a notification relay mechanism. For example, the service provider may notify a manufacturer of a defect and the manufacturer may notify suppliers and OEMs or ISOs. This may cause an OEM or ISO to set a defect resolution case.

Upon reception of a notification, the various agents may perform their own validation processes 350 to ensure that the defect notification actually relates to products for which they are responsible. Of course, a supplier need not engage in defect resolution for a component part that it does not manufacture. Following successful validation, the agents may engage in collaborative defect analysis 360.

Collaborative defect analysis 360 involves data exchange among the various agents to permit product performance analysis. As noted, the various agents may store product performance data along different data parameters. The agents may publish the parameters and the product performance data to each other to provide a broader set of data for defect analysis. The defect analysis 360 may identify a particular component part as a source of the product defect, in which case a supplier of the component may validate the component part (box 370) to confirm that it supplied the defective product. The defect analysis may conclude when each of the agents publish results from their own defect analyses and they agree 380, identifying a cause of the defect. When the defect analysis concludes, the OEM/ISO may set a new status on its defect case 390.

When the defect analysis concludes, the DAR system may engage a defect resolution process 400. The defect resolution process may engage other business processes performed by the manufacturer's computer system, such as a parts return and logistics process 410 to manage ordering of parts to repair the defective product. Depending on severity of the product defect and the extent to which it appears within the population of distributed products, the defect resolution process 400 may engage a recall process 420 to recall products in which the defect has not been detected. As noted, the defect resolution process 400 may update product performance data to reflect the product defect in its databases 430. If the defect analysis process identified product misuse as a likely cause of the product defect, the defect resolution process 400 may store update its database of technical information 450 indicating a need possibly to revise the manufacturer's product documentation to identify proper uses of the product. Finally, the defect analysis process 400 may update its defect resolution database 450 to add the identified defect to a log of product defects and to indicate diagnosed causes of the defect and resolution taken.

Consider operation of the DAR system in the context of a hypothetical product, a CT simulator device to be used in cancer treatment via radiation therapy. For purposes of this example, it may be assumed that the product includes three modules (modules 1-3) of which module 3 is the most expensive and also subject to compliance regulations. The product may have an expected availability rate of 99%, due to expense of other factors. The product may be assigned a serial number of 1000, module 1 may have a serial number 10001, module 2 may have a serial number 10002 and module 3 may have a serial number 10003. The product may be owned and operated by an OEM that captures performance data using a computer system equipped with a DAR according to the foregoing embodiments.

During the course of operation, the OEM may capture performance data. Performance data may be compared against the expected availability rate or against other performance indicators (e.g., trigger a defect case upon the 10^{th} product outage within a predetermined period of time). The OEM system may alert other parties in the market (manufacturers, component suppliers and service personnel (on site engineers)) of the defect case.

Responsive to the defect case, the other parties may supply additional performance data. For example, module supplier(s) may supply history data such as mean times between failures of the product components. An on site engineer may provide usage data for the product. Such information may be provided manually from these other parties or through automated data exchange protocols. Additionally, the defect system may retrieve the history of repair for the product. The defect system also may identify a possible resolution, for example, that one of the modules has an incompatible component.

Responsive to the resolution, the system may generate an alert for a design engineering team within the firm. The system also may initiate a notification for a recall and replacement of the defective module. Moreover, the system may identify a parts supplier of an impending recall and also about the compatibility issues. Finally, the system may update historical performance data and defect databases before closing the case status.

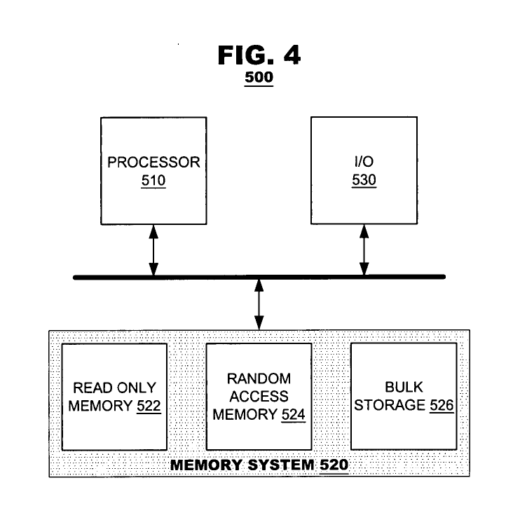

As noted, functionality of the foregoing embodiments may be provided on various computer platforms executing program instructions. One such platform 500 is illustrated in the simplified block diagram of FIG. 4. There, the platform 500 is shown as being populated by a processor 510, a memory system 520 and an input/output (I/O) unit 530. The processor 510 may be any of a plurality of conventional processing systems, including microprocessors, digital signal processors and field programmable logic arrays. In some applications, it may be advantageous to provide multiple processors (not shown) in the platform 500. The processor(s) 510 execute program instructions stored in the memory system. The memory system 520 may include any combination of conventional memory circuits, including electrical, magnetic or optical memory systems. As shown in FIG. 4, the memory system may include read only memories 522, random access memories 524 and bulk storage 526. The memory system not only stores the program instructions representing the various methods described herein but also can store the data items on which these methods operate. The I/O unit 530 would permit communication with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1. A defect analysis method, comprising:
responsive to product performance data, generating a defect analysis notification to other agents,
exchanging product performance data with the other agents,
performing a defect analysis upon the exchanged product performance data, and
responsive to the defect analysis, storing defect resolution data in a database.

2. The defect analysis method of claim 1, performed by a computer system of a manufacturer.

3. The defect analysis method of claim 1, performed by a computer system of a repair organization.

4. The defect analysis method of claim 1, performed by a computer system of a retailer.

5. The defect analysis method of claim 1, wherein the defect resolution data distinguishes product component failure from product mis-use.

6. The defect analysis method of claim 1, further comprising initiating a recall process.

7. The defect analysis method of claim 1, further comprising updating a product performance expectation database

8. A computer system, comprising:
a first database storing actual product performance data,
a second database storing expected product performance data,
a defect analyzer,
a performance analyzer to engage the defect analyzer based on a comparison of data from the actual product performance database and the expected product performance database, and
a defect resolution database to store data generated by the defect analyzer.

9. The computer system of claim 8, further comprising a communication manager to exchange product performance data with other computer systems.

10. The computer system of claim 8, to store data representing product documentation and to store product resolution data from the defect analyzer representative of product mis-use.

11. The computer system of claim 8, wherein the defect resolution data stores data representing component failure.

12. The computer system of claim 8, storing product performance data recorded by a product manufacturer.

13. The computer system of claim 8, storing product performance data recorded by a product repair organization.

14. The computer system of claim 8, storing product performance data recorded by a product retailer.

15. A computer readable medium storing program instructions that, when executed by an agent, causes the agent to:
generate a defect analysis notification to other agents in response to product performance data,
exchange product performance data with the other agents,
perform a defect analysis upon the exchanged product performance data, and
store defect resolution data in a database, responsive to the defect analysis.

16. The medium of claim 15, wherein the program instructions are executed by a computer system of a manufacturer.

17. The medium of claim 15, wherein the program instructions are executed by a computer system of a repair organization.

18. The medium of claim 15, wherein the program instructions are executed by a computer system of a retailer.

19. The medium of claim 15, wherein the defect resolution data distinguishes product component failure from product mis-use.

20. The medium of claim 15, wherein the agent initiates a recall process in response to the defect resolution data.

21. The medium of claim 15, wherein the agent updates a product performance expectation database.
